(19) United States
(12) Patent Application Publication
(10) Pub. No.: US 2022/0268395 A1
(43) Pub. Date: Aug. 25, 2022

(54) Outdoor triple action anchoring leveling device

(71) Applicant: Peter N. Glynos, Warren, NJ (US)

(72) Inventor: Peter N. Glynos, Warren, NJ (US)

(21) Appl. No.: 17/300,053

(22) Filed: Feb. 25, 2021

(51) Int. Cl. F16M 7/00

(52) U.S. Cl. CPC F16M 7/00

(57) ABSTRACT

A device for host structures having an elongated section, for attaching, leveling, stabilizing and protecting such host structures. The device includes: (a) a support pad having a top, a bottom and at least one side wall, and at least one groove on its top, adapted to receive an elongated section of the host structure, and having a plurality of anchor-receiving orifice; and (b) at least one triple action anchor, being inverted U-shaped and adapted to be inserted into opposing anchor-receiving orifices, and being adopted to straddle the elongated section, with sufficient length to extend through said orifices and into ground to anchor said support pad and said elongated section. Secondary stackable support pads increase the thickness of the device for steep slope leveling.

### REFERENCE TO RELATED APPLICATIONS

This application is not related to any prior applications or issued patents.

### BACKGROUND OF INVENTION

### a. Field of Invention

The present invention generally relates to devices that assist in connecting, anchoring and leveling other devices to which they are attached. The present invention devices are for structures (host devices) having an elongated metal section, or an elongated plastic section or other material elongated section, for attaching, leveling, stabilizing and protecting these structures. For example, a trampoline (host device) may be in a yard or other location where the ground is not flat. In another example, a folding beach chair (host device) might be on an unlevel beach. In yet another example, pipes (host device) positioned above ground, on ground, on a roof, or in a ditch, may need to be levelled or set at a certain angle for drainage or flow, such as 3 degrees above horizontal. The present invention devices may be used to solve all of these problems. The present invention devices include grooved leveling support pads and triple action anchors. These anchors wrap around a host device section, pass through the present invention leveling support pads and push into the ground, and thus: (1) hold the host device to the present invention device in its pad groove; (2) maintain the leveling of the host device; and (3) stabilize the host device position through ground anchoring.

### b. Description of Related Art

The following patents are representative of the field pertaining to the present invention:

U.S. Pat. No. 10,206,511 B2 to Peters describes a universal chair leveler provides chair leveling for outdoor concert, event or other use. The universal chair leveler comprises a body having an angled bottom and a support for receive a chair leg at its top. A support may have one or more distinct cavities to receive various types of chair legs. A telescopic support provides height adjustment to permit use on a variety of sloped or other non-uniform surfaces.

U.S. Pat. No. 9,717,336 B1 to Apple et al describes a chair wedge that includes: a first tier having a downward sloped first top surface from a first tier top rear edge to a first tier top front edge; a second tier recessed within a center portion of the first tier and having a downward sloped second top surface from a second tier top rear edge to a second tier top front edge, and wherein the downward sloped second top surface is at a lesser angle relative to a base surface than is the downward sloped first top surface; a cavity formed in a space differential between the downward sloped first top surface and the downward sloped second top surface; and a rear wall defined at an inward most portion of the cavity and configured in combination with the cavity to stop a chair leg from further movement when placed within the chair wedge.

U.S. Pat. No. 9,395,034 B1 to Rowland et al describes an equipment pad includes a base and a plurality of riser portions. The base includes a base surface that extends laterally outward and a base opening formed completely through the base surface. Each riser portion includes a top surface, a side wall, and an interior. The top surface is substantially level and continuous. The side wall tapers inward and extends upward from the base surface, elevating the top surface portion above the base surface. The interior, defined between the top surface and the side wall, is substantially hollow. The riser portions together define a single, continuous riser, at least one of the riser portions forming an angle with reference to an adjacent riser portion such that the riser includes at least one turn. The riser top surfaces together define a substantially level support surface for receiving the equipment unit, and the riser interiors align with the base opening so that the equipment pad is stackable.

U.S. Pat. No. 9,062,466 to Glynos describes a universal leveling device for outdoor structures of wood and other vulnerable materials for leveling, stabilizing and protecting against ground hazards, has at least a first and a second flat groove on its top, at right angle to each other, and on its bottom has first and second vee grooves each with two opposing angled walls. The reversible device can accommodate vertical and tilted support structures.

U.S. Pat. No. 5,966,881 to Kitagaki describes a base plate for foundation which is a board having a prescribed external size and possesses a bolt pore having an approximately cross shape at approximately the middle portion thereof and in which the top surface of the board except for the portion of the bolt pore has a prescribed area and a foundation of structure having the base plates for foundation arranged so that the area of projection chart thereof is minimized are provided.

U.S. Pat. No. 5,749,555 to Albrecht describes a height compensating device made from a non-toxic material defining a support surface of a predetermined shape and having a periphery with a sidewall extending downwardly and outwardly from said sidewall. The surface of the support surface is roughened to the roughness of a quartz number 4 grit or greater. The structure has a weight of 8 pounds or greater.

U.S. Pat. No. 5,725,188 to Monteiro, Jr. describes a lawn chair leveling block includes a portable rigid, flat ground-engaging pad designed to support the lawn chair in a level position on a sloped ground surface. The pad is provided with an upstanding elevation block having a deep groove along a top surface, and the groove is designed to cradle a U-shaped leg of the chair. Blind holes positioned in the pad at opposite ends of the elevation block are designed to support individual tubular, vertical chair legs. In addition to being utilized for leveling a lawn chair on a sloped surface, the block prevents a chair leg from sinking into soft soil so as to eliminate the risk of the chair tipping over.

U.S. Pat. No. 4,439,961 to Witte a leveling and locating or positioning device is disclosed which includes a force-bearing structure which is guided for vertical leveling movement by a vertical reference device which also provides a horizontal position reference. Horizontal movement of a tapered wedge device, which operatively interfaces with a sloped floor member of the force-bearing structure, causes vertical movement of the force-bearing structure and the resulting leveling function. A horizontal extender device, slidably mounted to and supported by the force-bearing structure, provides the horizontal locating or positioning function. A support device is operatively included or mounted to one end of the horizontal extender device and is configured to operatively interface with the member or device which is to be leveled and located or positioned.

U.S. Pat. No. D809,074 S to Irwin et al shows a riser for an exercise platform.

U.S. Pat. No. D627,074 to Hermans illustrates a grooved plinth.

U.S. Pat. No. D426,933 to Redfern shows a stackable leveling block.

Notwithstanding the prior art, the present invention is neither taught nor rendered obvious thereby.

### SUMMARY OF INVENTION

The present invention is a device for host structures having an elongated section, such as a pipe, beam, tube, rod, or frame, for attaching, leveling, stabilizing and protecting such host structures. The present invention minimally includes: (a) a support pad, said support pad having a top, a bottom and at least one side wall, said support pad having at least one groove on its top, said groove adapted to receive an elongated section of a host structure, said support pad having a plurality of anchor-receiving orifices, with at least one of said orifices being located on a first portion of said top and at least another of said orifices being located opposite said groove on a second portion of said top; and (b) at least one triple action anchor, being an inverted U-shaped anchor adapted to be inserted into opposing anchor-receiving orifices, and being adopted to fit over said elongated section, and having sufficient length to extend through said orifices and into ground to anchor said support pad and said elongated section.

In some embodiments of the present invention device, the groove is open at one end and is truncated at an opposite end so as to not extend through said support pad. The truncated end may be arcuated to receive round tubular host structure sections, or may have other cross-sections. In other embodiments, the groove is open-ended at both ends so as to have no end walls and runs the full length of said support pad.

In some embodiments, the groove has a rectilinear cross-section, and in others, the groove has an arcuated cross-section. In some embodiments, the groove has a half pipe cross-section.

In preferred embodiments, the support pad has at least two sets of two orifices for each set, each set having opposing orifices. The support pad of the present invention device may have a top view peripheral shape selected from the group consisting of square, rectangle, circle, oval and polygon. The support pad is preferably made of moisture resistant material, such as selected from the group consisting of plastic, rubber, recycled tires and combinations thereof. Preferably, the support pad is semi-flexible or marginally flexible to at least partially adapt to outdoor ground topography.

In some embodiments of the present invention device, the triple action anchor has an inverted u-shape with a flat top. In some embodiments, the triple action anchor has an inverted u-shape with an arcuated top. It may have other equivalently functional shapes, i.e., shapes that will serve to perform the three different anchor functions of: holding the host structure to the device (keeping the pad and the elongated section of the host together); elevating the host structure at the location where it is needed, and anchoring these into the ground.

In the present invention device, the support pad has a predetermined maximum thickness and said triple action anchor has legs that are at least 1.5 times said predetermined maximum thickness of said support pad and is adapted for earth penetration. Usually, the triple action anchors are multiples, even many multiples, of that thickness. For example, a support pad may be 2 or 3 inches thick, and the anchor may be a foot or more long.

In some embodiments of the present invention device, the triple action anchor has three interconnected components, said components being a top and rotatable opposing leg, said rotatable opposing legs being selected from the group consisting of: hand-crank auger; hand-crank cork screw; power driven augur; and power-driven cork screw.

In some embodiments of the present invention device, the support pad has a plurality of stacking stabilizers on said top and a plurality of stacking stabilizers on said bottom, said plurality of stacking stabilizers being a combination of nesting protrusions and recesses. Thus, in some embodiments of the present invention device, the device further includes: (c) at least one stackable secondary support pad for positioning under said support pad for increased height of support, and said at least one secondary support pad has anchor-receiving orifices positioned to correspond to said has anchor-receiving orifices of said support pad. These secondary support pads are placed under the primary support pad to increase thickness and thus further elevate the host structure where needed for better leveling. These secondary support pad has a top view peripheral shape that matches said support pad shape. Further, these secondary support pads preferably have a plurality of stacking stabilizers on said top and a plurality of stacking stabilizers on said bottom, said plurality of stacking stabilizers being a combination of nesting protrusions and recesses. In some embodiments, the secondary support pad is of even thickness, while in others they may have irregular thickness or be tapered to accommodate high slope areas. Thus, the secondary support pads may be tapered in a direction at a right angle to said groove of said support pad or tapered in a direction parallel to said groove of said support pad, or otherwise.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE SEVERAL VIEWS OF THE DRAWINGS

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1 shows a block diagram of some features of the present invention outdoor triple action anchoring leveling device;

FIG. 2 shows another block diagram of some other features of the present invention outdoor triple action anchoring leveling device;

FIG. 3 shows an oblique end view of a rectangular present invention outdoor triple action anchoring leveling device and FIG. 4 shows a side view thereof;

FIG. 5 shows a top view an alternative present invention outdoor triple action anchoring leveling device with rounded ends and with a groove that has two open ends, and FIG. 6 shows a side view thereof. and FIG. 7 shows an end view thereof;

FIG. 8 shows a front view of one embodiment of a present invention triple action anchor component having an arcuated top;

FIG. 9 shows a front view of one embodiment of a present invention triple action anchor component having a flat top;

FIG. 10 shows a combination of a present invention device with a three component anchor, in an exploded end view;

FIG. 11 shows another alternative present invention anchor component with drill-rotatable anchoring cork screw legs;

FIG. 12 shows an end view of a present invention device that includes an anchor with hand-crank auger legs;

FIG. 13 shows an oblique view of a present invention device attach to an elongated section of a trampoline base that includes a primary support pads and a tapered secondary support pad;

FIG. 14 shows an oblique end view of another present invention support pad having protruding stacking stabilizers and recessed stacking stabilizers and FIG. 15 shows an end view thereof.

### DETAILED DESCRIPTION OF THE EMBODIMENTS

The present invention relates to stabilizing, leveling devices that are anchored both to the item (host structure) that it serves, and to the ground or earth. The anchors are triple action anchors. The term “level” and “leveling” as used herein should be broadly taken to mean set or setting the host structure to a desired angle. For example, leveling a trampoline means getting as close to zero degrees as possible (horizontal), while leveling a water pipe may mean leveling at an angle of three degrees to comply with code or to enable draining when necessary. Also, in some cases leveling will mean less than horizontal even when horizontal is desired, such as in leveling a beach chair on a steep sand beach.

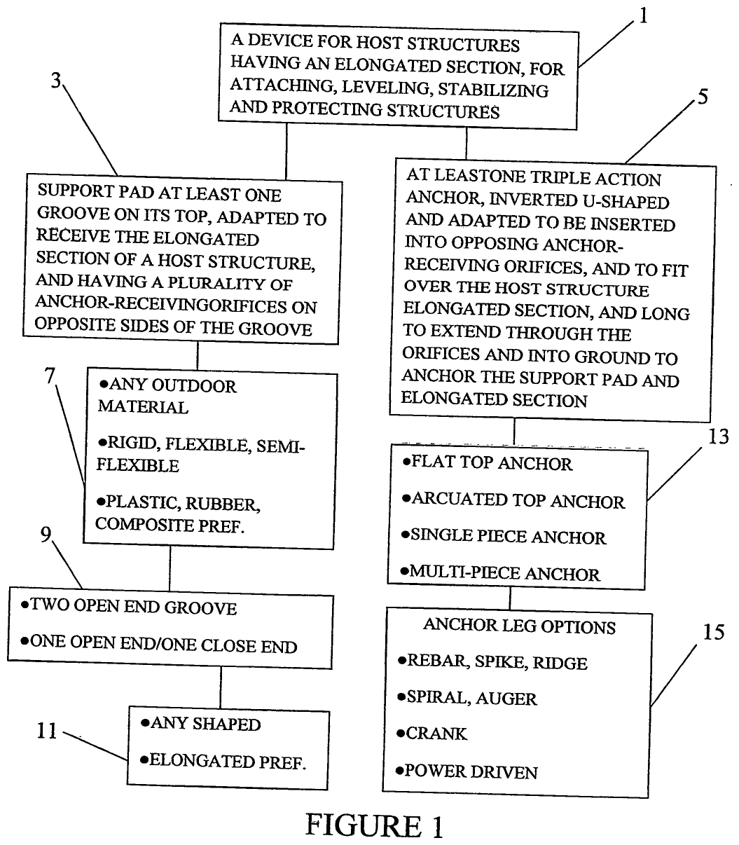

FIG. 1 shows a block diagram of some features of the present invention outdoor triple action anchoring leveling device, block 1, for attaching, stabilizing, leveling and protecting the host structure. The present invention attaches itself to the host structure elongated member; it stabilizes the structure by inhibiting it from undesirably moving; it levels the host by raising up a lower portion of the host structure, and it protects the host structure from torquing, sliding and eroding from ground contact. The present invention support pads, block 3, have at least one groove and usually have only one groove, but may have more. For example, these pads could have three open ended grooves, such as 3 parallel grooves, for supporting three conduits, such as water or electrical on-the-ground or in-the-ground conduits that need to be levelled; or have two grooves, one being single end open and the other being both ends open, so that a user may select positioning at an end of an elongated section of a host structure, such as an end of a trampoline base tube, or otherwise, such as in the middle of a trampoline base tube.

In FIG. 1, block 5, the anchors are described. They are triple action because they fit over the host structure; align the pad with the host structure and anchor both to the ground. When multiple pads are stacked, they also align these and keep them in place. These anchors may be flat or arcuated at the top, block 13, depending upon their uses. Arcuated as in a semi-circle to straddle circular tubing and flat to straddle squared beams or similar structures. To enhance ground gripping, these anchors may have rebar shapes, spirals, spikes, augers or ridges, block 15. They may be enhanced for easy ground insertion, such as with hand cranks or with drill or other driver receivers at the top of the anchor legs (which would be rotatable within the anchor top).

The support pads may be made of any outdoor material, block 7, such as plastic, metal, wood, closed pore foam (e. g., rigid urethane), rubber or composite. Composite materials may be wood, wood-metal, synthetics-wood, synthetics-metal, rubber-plastic or any other outdoor weather resistant composite. One preferred composite is a recycled tire/rubber/plastic composite. These pads may be rigid, flexible or semi-flexible. For some applications, semi-flexible is preferred to allow for pad adjustments to rough topography. As mentioned, the pads may be open ended at both ends or at one end, block 9. They may have any shape, block 11, i. e. a top view footprint, such as square, rectangle, circular oval, or polygonal or irregular and may have one side wall (as in a circle or oval), or more, such as in a triangle or rectangle. Elongated shapes are preferred because the host structure has an elongated section that is supported by the pad.

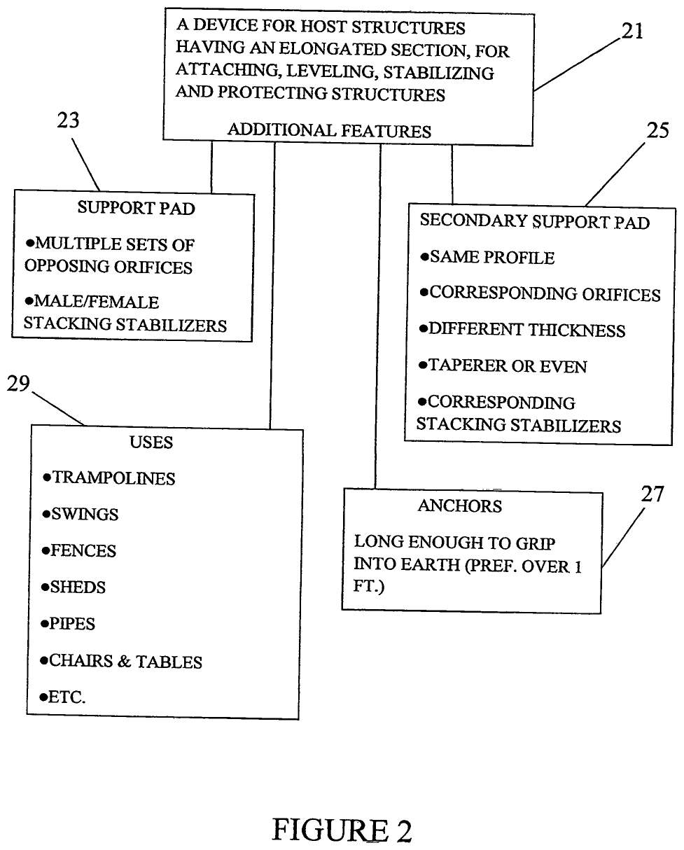

FIG. 2 shows another block diagram of some additional features of the present invention outdoor triple action anchoring leveling device, block 21. Thus, the support pads have at least one set of orifices on opposite sides of the groove, but preferably have multiple sets of orifices, block 23, for receiving the anchor legs so that two or more anchors are preferably used. The support pads (aka primary pads) may have male and female stacking stabilizers in the form of outcrops and matching insets. There may be one or more secondary support pads, block 25, under the primary pad (top pad with the groove(s). They preferably, but not necessarily, will have the same profile (footprint) as the top support pad, and have corresponding (aligned) orifices. These secondary support pads may have the same of different thicknesses from the primary pad and from each other to allow for varying height adjustments for more refined leveling. They may of even thickness or tapered thickness and may have the preferred male and female stacking stabilizers. The anchors, block 27, must be long enough to grip the earth and in many instances are preferably a foot or more in height (leg length).

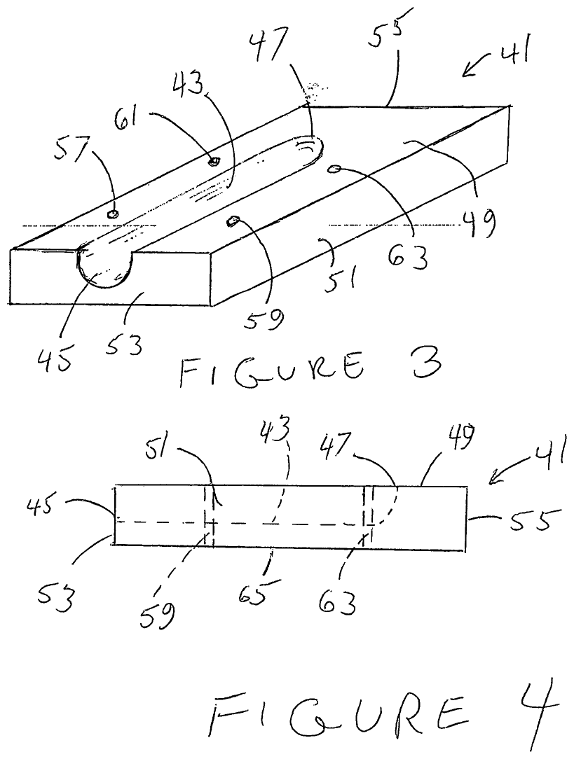

FIG. 3 shows an oblique end view of a rectangular present invention outdoor triple action anchoring leveling device 41 and FIG. 4 shows a side view thereof. Device 41 is a generally rectangular pad of even thickness. It has ends 53 and 55 and sides, such as side 51, a top 49 and a bottom 65. Top 49 has an elongated groove 43 with an open end 45 and a closed end 47 that is adapted to receive an end of an elongated tubular section of a host structure, such as a trampoline base. There are two sets of orifices for the legs of two anchors to penetrate and lodge into ground. Thus, orifices 57 and 59 are on opposite sides of the groove 43, as are orifices 61 and 63. Anchors with arcuated tops would be preferred here. The trampoline base section end would fit into groove 43, and the anchors would each straddle the trampoline base section and penetrate the pad 41 and lodge into the ground to prevent lateral motion and to maintain the connection of the pad 41 with its host structure.

FIG. 5 shows a top view an alternative present invention outdoor triple action anchoring leveling device 71 with rounded ends 77 and 99, top 73, sides 75 and 85, and with a groove 79 that has two open ends 81 and 83. FIG. 6 shows a side view thereof and FIG. 7 shows an end view thereof, wherein identical parts are identically numbered. There are three sets of anchor-receiving orifices, namely, orifices 89 and 97, orifices 87 and 91 and orifices 93 and 95, so that up to three anchors may be used with this pad 71. Note that the end view of FIG. 7 reveals that the groove 79 not only passes all the way through the pad 71, but has a rectilinear cross-section, which is best for rectangular frames and square tube elongated sections of host structures.

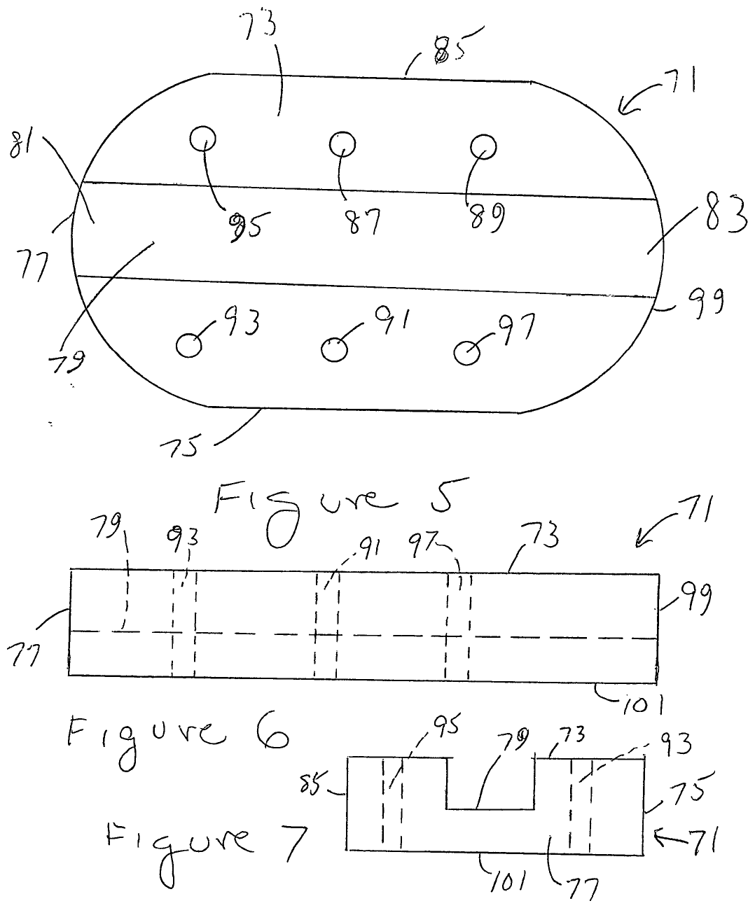

FIG. 8 shows a front view of one embodiment of a present invention triple action anchor 111 having an arcuated top 113 in the shape of a semi-circle to straddle a round pipe or tube or bar. Anchor 111 includes downwardly extended legs 115 and 117, pointed ends 119 and 121 for earth penetration, and spikes such as spike 123, biased upwardly for ease of insertion and resistance to removal. This anchor 111 is made of metal or heavy-duty plastic and may be, for example ½ an inch or greater thickness and about 1.3 feet in height.

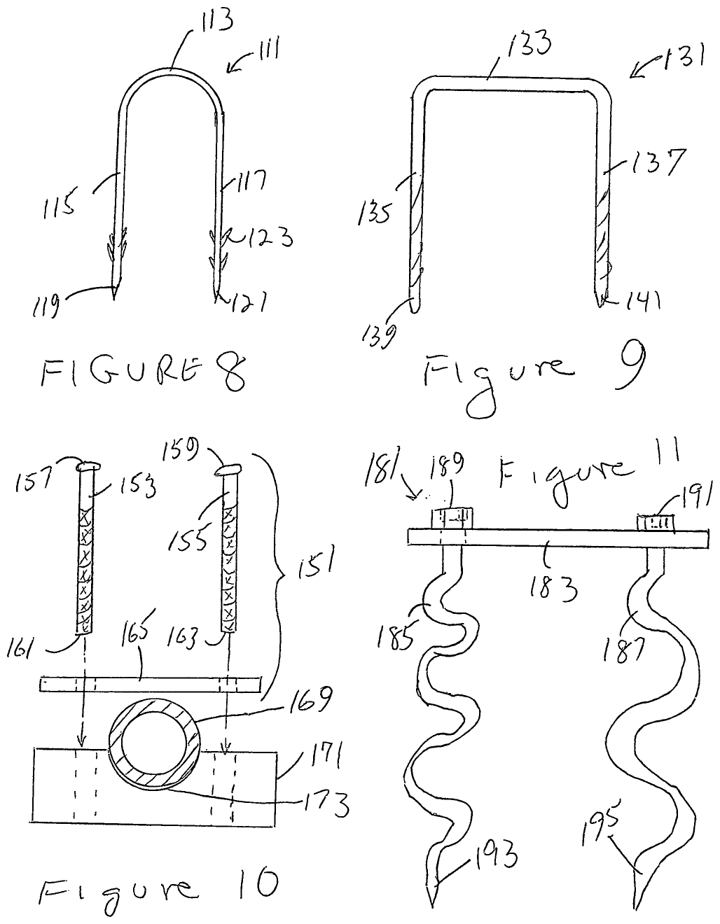

FIG. 9 shows a front view of one embodiment of a present invention triple action anchor 131 having a flat top 133 to accommodate and fit onto flat pipes, tubes, rods, beams, etc. of the host structure. It has legs 135 and 137 with spiral ridges to aid in gripping the earth, and has optional pointed ends 139 and 141. This anchor 131 could be machine bent rebar stock.

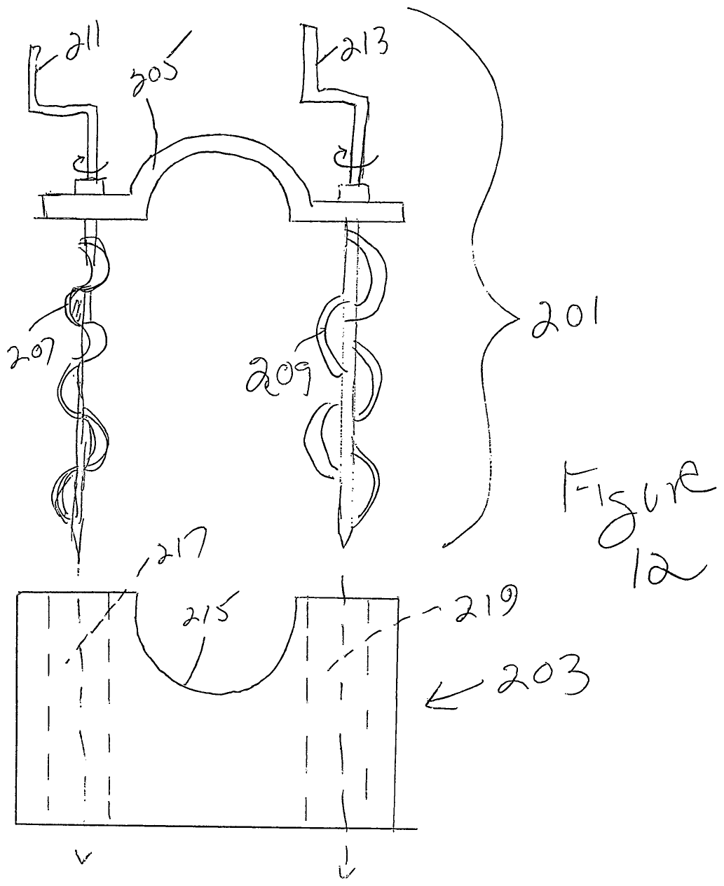

FIG. 10 shows a combination of a present invention device with a three-component anchor 151, and a primary support pad 171 in an exploded end view for attachment to tube 169. Anchor 151 includes single piece top 165, and separate ridged legs 157 and 159. Host structure tube 169 is placed in double open-ended groove 173 of primary support pad 171, and then ends 161 and 163 of legs 157 and 159 are passed through the orifices of top 165and then through the orifices of pad 171, with top 165 resting upon tube 169. Next, the legs 157 and 159 are hammered into ground to secure everything in place and to clamp the tube 169 in the pad groove 173. This secures the host structure and raises up the elongated tube 169 for leveling. Secondary support pads (not shown) may be added as needed to further accommodate leveling.

FIG. 11 shows another alternative present invention multi-component anchor 181, with drill-rotatable anchoring cork screw legs 185 and 187, with pointed ends 193 and 195. The tops of legs189 and 191 have hexagonal or other shaped recesses to receive hex drill or hex ratchet or other driver to assist in earth penetration after inserted into a support pad and over an elongated section of a host structure.

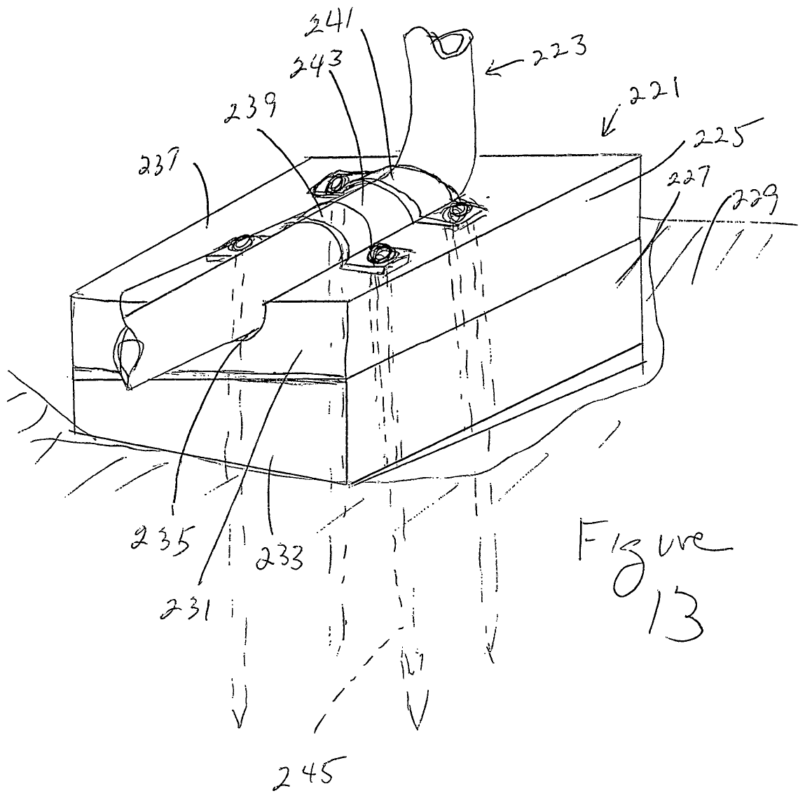

FIG. 12 shows an end view of a present invention device that includes an anchor 201, with top 205 and hand-crank auger legs 207 and 209, and support pad 203. Support pad 203 has larger diameter orifices 217 and 219 to receive auger legs 207 and 209. Hand cranks 211 and 213, at the top end of legs 207 and 209 respectively may be rotated by hand to screw the auger legs into the ground. (The cranks are not shown to scale, but would have longer handles for holding while cranking.)

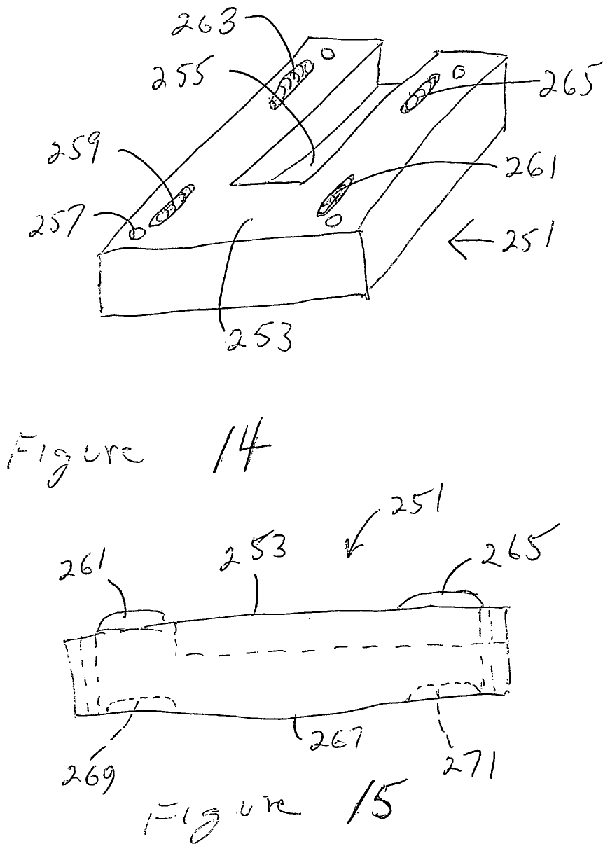

FIG. 13 shows an oblique view of a present invention device 221 attached to an elongated section 243 of a trampoline base 223 that includes a primary support pad 225 and a tapered secondary support pad 227. Primary support pad 225 has a groove 235 that has an open end at wall 231 and a closed end at top 237 that receives and holds elongated section 243 of a host structure, here, trampoline base 223.The two anchors 239 and 241 are three-piece anchors, each with a pair of very long legs such as leg 245 that penetrate ground 229. Secondary support pad 227 shows wall 233 being tapered at a right angle to and below groove 235, but it need not be tapered or could be tapered in a different direction, such as parallel to or at 45 degrees to the groove 235.

FIG. 14 shows an oblique end view and FIG. 15 shows an end view of another present invention support pad 251, with top 253 having a one open end groove 255, and having anchor-receiving orifices such as orifice 257. Pad 251 also has protruding (male) stacking stabilizers 259, 261, 263 and 265 and recessed (female) stacking stabilizers 269 and 271 (FIG. 15) with two others not shown. These would correspond to similar male and female stacking stabilizers on secondary support pad(s) so that they align and stay aligned when stacked to increase height of an elongated section of a host structure.

Although particular embodiments of the invention have been described in detail herein with reference to the accompanying drawings, it is to be understood that the invention is not limited to those particular embodiments, and that various changes and modifications may be included therein by one skilled in the art without departing from the scope or spirit of the invention as defined in the appended claims. For example, the groove of the support pad could be curved instead of straight to accommodate a curved elongated section of a host structure. The groove could have varying depth (such as to receive a section of a wheel or could even have other footprints to accommodate a host structure with a unique elongated base, such as a linear base with a crisscross member or members protruding therefrom. Further, the legs of the anchors could be pre-embedded, such as in concrete or other material, and the one or more pads added on, followed by the host structure, followed by a snap-on, screwed on or otherwise fitted and attached anchor top, such as in FIG. 11.

What is claimed is:

1. A device for host structures having an elongated metal section, or an elongated plastic section or other material elongated section, for attaching, leveling, stabilizing and protecting said structures, which comprises:
a) a support pad, said support pad having a top, a bottom and at least one side wall, said support pad having at least one groove on its top, said groove adapted to receive an elongated section of a host structure, said support pad having a plurality of anchor-receiving orifices, with at least one of said orifices being located on a first portion of said top and at least another of said orifices being located opposite said groove on a second portion of said top;
b) at least one triple action anchor, being an inverted U-shaped anchor adapted to be inserted into opposing anchor-receiving orifices, and being adopted to fit over said elongated section, and having sufficient length to extend through said orifices and into ground to anchor said support pad and said elongated section.

2. The device of claim 1 wherein said groove is open at one end and is truncated at an opposite end so as to not extend through said support pad.

3. The device of claim 2 wherein said truncated opposite end is arcuated.

4. The device of claim 1 wherein said groove is open-ended at both ends so as to have no end walls and runs the full length of said support pad.

5. The device of claim 1 wherein said groove has a rectilinear cross-section.

6. The device of claim 1 wherein said groove has an arcuated cross-section.

7. The device of claim 6 wherein said groove has a half pipe cross-section.

8. The device of claim 1 wherein said pad has at least two sets of two orifices for each set, each set having opposing orifices.

9. The device of claim 1 wherein said support pad has a top view peripheral shape selected from the group consisting of square, rectangle, circle, oval and polygon.

10. The device of claim 1 wherein said support pad is made of moisture resistant material selected from the group consisting of plastic, rubber, recycled tires and combinations thereof.

11. The device of claim 1 wherein said triple action anchor has an inverted u-shape with a flat top.

12. The device of claim 1 wherein said triple action anchor has an inverted u-shape with an arcuated top.

13. The device of claim 1 wherein said support pad has a predetermined thickness and said triple action anchor has legs that are at least 1.5 times said predetermined thickness of said support pad and is adapted for earth penetration.

14. The device of claim 1 wherein said support pad has a plurality of stacking stabilizers on said top and a plurality of stacking stabilizers on said bottom, said plurality of stacking stabilizers being a combination of nesting protrusions and recesses.

15. The device of claim 1 wherein said triple action anchor has three interconnected components, said components being a top and rotatable opposing leg, said rotatable opposing legs being selected from the group consisting of: hand-crank auger; hand-crank cork screw; power driven augur; and power-driven cork screw.

16. The device of claim 1 which further includes:
c) at least one secondary support pad for positioning under said support pad for increased height of support, and said at least one secondary support pad has anchor-receiving orifices positioned to correspond to said has anchor-receiving orifices of said support pad.

17. The device of claim 16 wherein said at least one secondary support pad has a top view peripheral shape that matches said support pad shape.

18. The device of claim 16 wherein said at least one secondary support pad is tapered in a direction at a right angle to said groove of said support pad.

19. The device of claim 16 wherein said at least one secondary support pad is tapered in a direction parallel to said groove of said support pad.

20. The device of claim 16 wherein said at least one secondary support pad has a plurality of stacking stabilizers on said top and a plurality of stacking stabilizers on said bottom, said plurality of stacking stabilizers being a combination of nesting protrusions and recesses.
